(19) United States
(12) Patent Application Publication
(10) Pub. No.: US 2023/0108037 A1
(43) Pub. Date: Apr. 6, 2023

(54) Systems And Methods To Share A Ride In A Vehicle

(71) Applicant: Bala Technologies LLC, Los Gatos, CA (US)

(72) Inventor: Eiman Zolfaghari, Los Gatos, CA (US)

(21) Appl. No.: 17/961,349

(22) Filed: Oct. 6, 2022

Related U.S. Application Data
(60) Provisional application No. 63/252,907, filed on Oct. 6, 2021.

(51) Int. Cl. G06Q 50/30; G06Q 30/06; G01C 21/34

(52) U.S. Cl. CPC G06Q 50/30; G06Q 30/0645; G01C 21/3438

(57) ABSTRACT

A transport arrangement system responds to a request for a shared ride received from a user device by accessing a data store of the transport arrangement system to identify user data associated with users of the transport arrangement system. Instructions stored within a memory of the transport arrangement system and associated with search software may be executed by a processor of the transport arrangement system to identify at least one other user. Based on an output of the search software, a communication channel is established between the first device and a second device of the other user to enable a generation, via the transport arrangement system as an intermediary to the first device and the second device, of shared ride data. One or more resources can be deployed to facilitate a shared ride between the one user and the other user according to the shared ride data.

### CROSS-REFERENCE TO RELATED APPLICATION

The present filing claims priority to U.S. Provisional Patent Application Ser. No. 63/252,907, filed on Oct. 6, 2022, entitled “MARKETPLACE PRODUCT WHERE RIDERS FIND OTHER RIDERS BASED ON A SPECIFIC ROUTE AND TIME AND ARE ABLE TO COORDINATE SHARING A RIDE”, which is hereby incorporated by reference in its entirety.

### BACKGROUND

It is sometimes convenient or necessary to use a rental vehicle for various purposes such as, for example, to travel from one's residence to an airport. The cost associated with using a rental vehicle can be high at times. Consequently, a customer would prefer to minimize the cost if feasible to do so. One way to do this is to share a ride with other people. However, there can be some disadvantages in doing this. For example, a transportation services provider such as, for example, a taxi service or a ride share service, may place two or more passengers in a vehicle and charge each passenger an amount that is less than what would be charged for a solo passenger in the vehicle. While reducing the cost of travel in this manner may be desirable, one has, typically, little or no choice in the selection of one's co-passengers or any say in the amount to be paid for travel. It is therefore desirable to provide a solution that addresses such shortcomings in conventional practice.

### SUMMARY

An aspect of the disclosure is a method to facilitate a shared ride. The method includes accessing, in response to a shared ride request obtained from a first device associated with one user of a transport arrangement system, a data store of the transport arrangement system to identify user data associated with one or more users of the transport arrangement system. One or more processors of the transport arrangement system may execute instructions stored within a memory of the transport arrangement system and associated with search software of the transport arrangement system to identify at least one other user of the transport arrangement system. Based on an output of the search software, a communication channel is established between the first device and a second device of the at least one other user to enable a generation, via the transport arrangement system as an intermediary to the first device and the second device, of shared ride data. The transport arrangement system may then cause a deployment of one or more resources to facilitate a shared ride between the one user and the at least one other user according to the shared ride data.

In general, the first example embodiment is directed at a method to facilitate a shared ride request received by a transport arrangement system from a first user device of a first user. The transport arrangement system facilitates the shared ride in part by searching for, and identifying, one or more other users seeking shared rides (such as, for example, a second user) that may be of interest to the first user. The transport arrangement system establishes a communication channel between the first device and a second device of the second user to enable a generation, via the transport arrangement system as an intermediary to the first device and the second device, of shared ride data. The transport arrangement system may then cause a deployment of one or more resources to facilitate a shared ride between the first user and the second user, based on the shared ride data.

In a second example embodiment in accordance with the disclosure, a method includes transmitting, by a first device associated with a first user of a transportation arrangement system, based on executing instructions stored within a memory of the first device, to the transportation arrangement system, a first request to obtain from the transportation arrangement system, one or more proposed shared rides sought by one or more other users of the transport arrangement system; receiving, by the first device, from the transportation arrangement system, information about at least a first proposed shared ride sought by a second user of a second device; establishing, by the first device with the second device, via the transport arrangement system operating as an intermediary to the first device and the second device, a communication to discuss a shared ride; transmitting, by the first device to the transportation arrangement system, based on executing instructions stored within the memory of the first device, a second request to arrange for deployment of a resource to facilitate the shared ride of the first user and the second user; and receiving, by the first device from the transportation arrangement system, information about the deployment of the resource.

In general, the second example embodiment is directed at a method to respond to a shared ride request originated by a first user device of a first user. The request is directed at receiving from a transportation arrangement system, information about at least a first proposed shared ride sought by a second user of a second device. The transport arrangement system can operate as an intermediary to the first device and the second device for establishing communication to discuss establishing a shared ride. The first device may then transmit a second request to the transportation arrangement system to arrange for deployment of a resource to facilitate the shared ride of the first user and the second user. The first device may receive from the transportation arrangement system, information about the deployment of the resource.

In a third example embodiment in accordance with the disclosure, a transportation arrangement system includes a processor and a memory containing computer-executable instructions. The processor is configured to access the memory and execute the computer-executable instructions to perform operations that include performing, in response to a shared ride request obtained from a first device associated with one user of the transport arrangement system, a search of the data store to identify at least one other user of the transport arrangement system; establishing, based on the search, a communication channel between the first device and a second device of the at least one other user of the transport arrangement system to enable a generation of shared ride data; and causing a deployment of one or more resources to facilitate a shared ride between the one user and the at least one other user according to the shared ride data.

In general, the second example embodiment is directed to a processor that executes instructions stored in a memory to perform actions in response to a shared ride request originated by a user device of a transport arrangement system. The actions can include a search of a data store containing user data to identify at least one other user of the transport arrangement system. Based on the search, a communication channel may be established between the first device and a second device of the other user in order to generate shared ride data. A deployment of one or more resources may then be made to facilitate a shared ride between the one user and the other user according to the shared ride data

These and other objects, features, and characteristics of the apparatus, system, and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 illustrates an example system that can be used to arrange for sharing a ride in a vehicle in accordance with the disclosure.

FIG. 2 shows a flowchart of an example method to make an arrangement to share a ride in a vehicle in accordance with the disclosure.

FIG. 3 illustrates some functional blocks that can be included in a computer that is configured to allow two or more people to make an arrangement to share a ride in a vehicle in accordance with the disclosure.

FIG. 4 shows some example components that can be included in a computer that is configured to allow two or more people to make an arrangement to share a ride in a vehicle in accordance with the disclosure.

FIG. 5 shows some example components that can be included in a device that may be used by a user of the transportation arrangement system to make an arrangement to share a ride in a vehicle in accordance with the disclosure.

### DETAILED DESCRIPTION

Throughout this description, embodiments and variations are described for the purpose of illustrating uses and implementations of the inventive concept. The illustrative description should be understood as presenting examples of the inventive concept, rather than as limiting the scope of the concept as disclosed herein. For example, it will be understood that various words, labels, and phrases are used herein for description purposes and should not be interpreted in a limiting manner.

In particular, the word “example” as used herein is intended to be non-exclusionary and non-limiting in nature. One of ordinary skill in the art will understand the principles described herein and recognize that these principles can be applied to a wide variety of applications and situations, using a wide variety of tools, processes, and physical elements.

Words such as “implementation,” “application,” “scenario,” “case,” and “situation” must be interpreted in a broad context, and it must be understood that each such word represents an abbreviated version of the phrase “In an example “xxx” in accordance with the disclosure” (where “xxx” corresponds to “implementation,” “application,” “scenario,” “case,” “situation” etc.).

The word “user” as used herein is a shortened version of “user of the transportation arrangement system in accordance with the disclosure” and must be understood accordingly. The words “user device” and “device” may be used interchangeably and must be understood in the context in which used. The word “information” as used herein may be embodied in various forms including, for example, in the form of digital data stored in a device and/or conveyed from one device to another. The digital data may be generated, for example, by encoding a voice signal, by digitizing text, and/or by digitizing an image. It must be understood that the word “execute” as used herein, particularly with reference to a computing device, refers to a processor that executes computer-executable instructions stored in a memory or storage device.

The labels “personal communication device,” “client device,” and “user device” as used herein refers to any of various types of devices that may be used for various purposes, including for purposes of communicating information (via voice, text, and/or images, for example). A non-exhaustive list of personal communication devices can include a smartphone, a tablet computer, a phablet (phone plus tablet), a laptop computer, a wearable device (a smartwatch, for example), and a desktop computer. In an example use-case scenario, information containing text and/or image content may be propagated from a smartphone (a personal communication device operated by a first user) to a laptop computer or a desktop computer (another personal communication device operated by a second user).

Sharing a vehicle amongst multiple riders offers various benefits. In some cases, making arrangements for sharing a vehicle may be relatively straightforward and simple, such as, for example, by talking/communicating among friends, colleagues, and/or family members. However, this traditional approach has several limitations such as, for example, the number of people who can be approached for sharing the vehicle may be limited (friends circle, family circle, etc.). As another example, it may be undesirable to bother people. As yet another example, it may be undesirable to obligate people (pressing a family member, for example).

In view of such issues, an individual may opt to use a commercial entity (taxi service, ride-share service, limousine service, etc.) and allow the commercial entity to make the necessary arrangements for sharing a vehicle. Typically, in this scenario, the individual has little, or no, say in the matter as far as choice of co-passengers and pricing is concerned. Furthermore, the individual may have to make certain accommodations, such as, for example, as far as a travel route is concerned (diversions to pick up or drop off co-passengers) and/or time delays while waiting to pick up or drop off co-passengers.

Consequently, it is desirable to be provided with a better way to arrange for, and share a ride in a vehicle. Firstly, it is desirable to be offered a system that allows a person access to a large pool of people from which a selection can be made. Secondly, it is desirable to eliminate, or at least minimize, an amount of time spent in using the system for this purpose.

Traditionally, even if a system provides access to a large pool of people, setting up conversations among the pool of people presents a challenge because of the lack of availability of a suitable infrastructure to do so. Group conversations (via telephone or via a video platform, for example) are not only time-consuming but also require contact information (phone number, email addresses, etc.), thereby not only limiting the number of people involved but also preventing access to a wider pool of people. Even if group conversations are feasible, it may be hard and/or inconvenient to agree upon a time to carry out the group conversation, particularly, if the people involved are busy and/or if people cannot agree upon a suitable time. Consequently, traditional systems fail to satisfy the need to allow convenient interaction between a large number of individuals for purposes of discussing and sharing a ride in a vehicle.

It is therefore desirable to provide a system that offers various types of services in an automated manner and addresses various traditional shortcomings such as the ones described above. A system in accordance with the disclosure can include various devices such as, for example, various types of user devices that are communicatively coupled to one or more computers. The services can, for example, pertain to presenting to an individual seeking to share a ride in a vehicle, a wide range of choices in terms of potential co-passengers, eliminate the need to have contact information of all potential co-passengers, allow considering of multiple options based on the individual's own schedule, allow interaction between the individual and a few potential co-passengers that the individual finds selectively suitable to share a ride, allows for flexibility in negotiating travel routes and times, and other such advantages.

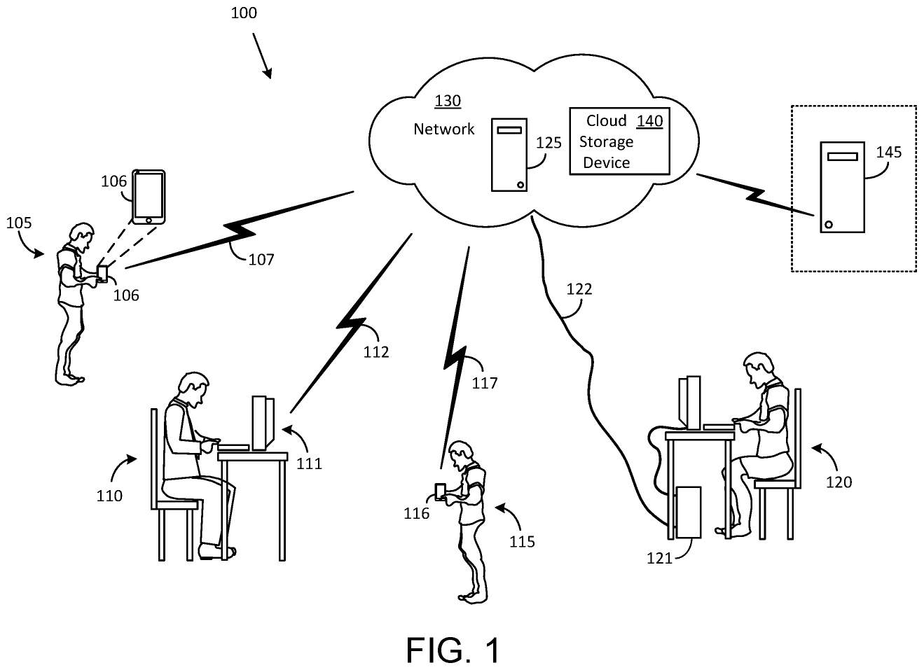

FIG. 1 illustrates an example transport arrangement system 100 that can be used to arrange for sharing a ride in a vehicle in accordance with the disclosure. More particularly, the transport arrangement system 100 may be utilized to, amongst other things, establish, as an intermediary between a first device of a first user from which a shared ride request is received and a second device of a second user, a communication channel between the first device and the second device in which the transport arrangement system 100 identifies the second device based on a search procedure performed by the transport arrangement system 100 in response to the shared ride request.

In the example configuration shown in FIG. 1, the transport arrangement system 100 has a distributed architecture where various components of the transport arrangement system 100 are provided in various example devices. The various example devices can include a smartphone 106, a smartphone 116, a laptop computer 111, a desktop computer 121, a cloud computer 125, and a cloud storage device 140. The smartphone 106, the smartphone 116, the laptop computer 111, and the desktop computer 121 are a few examples of client devices. Each of these devices and similar devices operated by various users may be referred to herein in some cases, as a personal communication device or a client device.

The various devices are communicatively coupled to each other via a network 130. The network 130, which can be any of various types of networks such as, for example, one or more of a wide area network (WAN), a local area network (LAN), a public network, and/or a private network, may include various types of communication links (a wired communication link, a wireless communication link, an optical communication link, etc.) and support one or more of various types of communication protocols (Transmission Control Protocol (TCP), Internet Protocol (IP), Ethernet, Post Office Protocol (POP), Simple Mail Transfer Protocol (SMT), File Transfer Protocol (FTP), Hyper Text Transfer Protocol (HTTP), and Hyper Text Transfer Protocol Secure (HTTPS), etc.)

In the illustrated example scenario, the smartphone 106 of the user 105 is coupled to the network 130 via a wireless communication link 107, the laptop computer 111 of the user 110 is coupled to the network 130 via a wireless communication link 112, the smartphone 116 of the user 115 is coupled to the network 130 via a wireless communication link 117, and the desktop computer 121 of the user 120 is coupled to the network 130 via a wired communication link 122. In other scenarios, a wireless communication link may be replaced with any of various other types of links such as, for example a wired communication and/or an optical link.

In an example embodiment in accordance with the disclosure, the cloud computer 125 is configured to host a portion of the transportation arrangement system 100 that can be accessed by use of any of the example client devices for executing a collaborative arrangement between two or more users to share a ride in a vehicle. For example, the cloud computer 125 can include a data store in which is stored various types of information associated with the various users of the transport arrangement system 100, such as, for example, personal preferences and travel-related information. The travel-related information can include, for example, travel routes, maps, vehicle information, and financial data related to travel.

In an example operational scenario, a software application may be launched at the smartphone 106 to enable the smartphone 106 to access the cloud computer 125. The software application can include an application programming interface (API) that cooperates with software provided in the cloud computer 125 to display, for example, a webpage or a graphical user interface (GUI) on the smartphone 106. The webpage or GUI may be used by the user 105 to enter information when seeking to share a ride in a vehicle and to communicate with one or more users for arranging to share a ride in a vehicle.

In some scenarios, the cloud computer 125 may be configured to communicate with an external server computer 145 for executing some operations in accordance with the disclosure. In some cases, the external server computer 145, which is external to the transportation arrangement system 100, may be owned, operated, and maintained by various entities such as, for example, a ride share provider (such as Uber®, Lyft®, etc.), a taxi services provider, or a limousine services provider. In an example implementation in accordance with the disclosure, a software application may be launched at a user device such as, for example, the smartphone 106, to enable the user device to access the external server computer 145 via the cloud computer 125. The software application can include an API that cooperates with software provided in the cloud computer 125 and/or software provided in the external server computer 145 to allow the external server computer 145 to display, for example, a webpage or a GUI on the user device. In an example scenario, the webpage or GUI is associated with a ride share provider and may display content that may be pertinent to a ride share operation such as, for example, a description of a ride share vehicle, a map, and a travel route. A ride share vehicle is one example of a vehicle that may be used for sharing a ride in accordance with the disclosure. Other vehicles can include a personal vehicle of a user such as, for example, the user 105 of the smartphone 106.

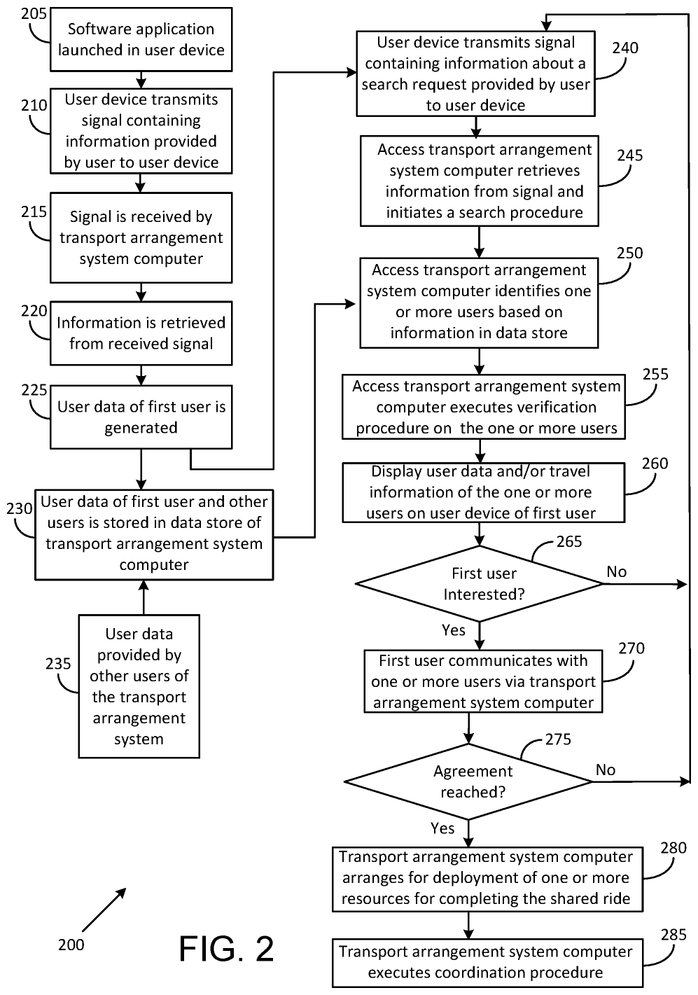

FIG. 2 shows a flowchart of an example method 200 to use the system 100 to make an arrangement to share a ride in a vehicle in accordance with the disclosure. The method 200 is described below by referring to various devices and users shown in FIG. 1. However, it must be understood that this is done for purposes of description and that the various operations indicated in the method 200 can be executed on various other platforms and systems and in various other ways that can be understood in view of the description herein.

At block 205, a software application may be launched in a user device, such as, for example, in the smartphone 106, to enable the user device to access a transport arrangement system computer, which in this example description can be the cloud computer 125. In another embodiments, the transport arrangement system computer can be, for example, a server computer. The server computer may be associated with an institution, a company, a service, or a business entity, for example. The software application can be downloaded into the user device from any computer that is configured to operate as a store for software applications (including, for example, the cloud computer 125). The software application can include an API that cooperates with software provided in the cloud computer 125 to display, for example, a webpage or a GUI on the user device. The webpage or GUI may be used by a first user, such as, for example, the user 105 of the smartphone 106, to enter information when seeking to share a ride in a vehicle and to communicate with one or more users for arranging to share a ride in a vehicle.

The webpage or GUI may be used by the first user to perform various operations such as, for example, setting up an online profile and executing a secure login procedure. Executing a secure login procedure can include the cloud computer 125 authenticating an access of the first user to a software service and related data available at the cloud computer 125 by use of a user name and a password or PIN. Setting up an online profile can include agreeing to abide by a set of rules and guidelines that may be specified by any of various entities, such as, for example, by a services provider who administers the transportation arrangement system. Setting up an online profile can further include providing information such as, for example, a legal name, a user name, a profile picture, an address, a phone number, a password, a personal identification number (PIN), and billing information. Some of the information, such as, for example, the profile picture and user name, may be made visible to other users of the transportation arrangement system.

The software application in the user device may convert the information pertaining to the online profile and the secure login procedure into a format that is suitable for transmission to the cloud computer 125. In an example scenario, the smartphone 106 (user device) may convert the information into digital data that is encoded into a cellular signal that is suitable for conveying digital data over a cellular transmission link such as, for example, the wireless communication link 107 shown in FIG. 1.

At block 210, the user device transmits the cellular signal to the cloud computer 125 (for example, the smartphone 106 transmits the cellular signal to the cloud computer 125 via the wireless communication link 107). At block 215, the cloud computer 125 receives the cellular signal.

At block 220, the cloud computer 125 retrieves the digital data contained in the cellular signal. Retrieving the digital data can include a decoding procedure applied to the cellular signal by circuitry in the cloud computer 125. The circuitry in the cloud computer 125 can include, for example, a receiver device that receives the cellular signal and conveys the digital data contained in the cellular signal to one or more data decoders that decode information contained in the digital data.

At block 225, the information contained in the digital data is used by the software in the cloud computer 125 to generate user data of the first user that can be viewed by other users.

At block 230, the user data of the first user is stored in a data store of the cloud computer 125. The user data of the first user may include the online profile of the first user and can further include information provided by the first user via the user device pertaining to shared rides associated with the first user. Information related to shared rides associated with the first user can include a shared ride history that includes information about previous shared rides of the first user and future shared rides that the first user may expect to undertake. Shared ride history can include information such as origination addresses, destination addresses, type of vehicles used, number of co-passengers, and personal preferences of the first user. Future shared rides of the first user may, for example, pertain to vacation travel where the first user expects to use a shared ride to an airport for example.

User data of other users may be similarly obtained and included in the data store as indicated at block 235. The data store can thus contain user data of “n” users (n≥2). The user data of the other users can include an online profile of each user, shared ride history of each user, future shared rids of each user, and shared ride requests originated by one or more users.

At block 240, the software application may be launched once again in the user device (if not already launched) to enable the user device to log in to the cloud computer 125 and allow the first user to convey to the cloud computer 125, information pertaining to a shared ride request.

In this scenario, the API in the user device enables the software application of the user device to interact with software in the cloud computer 125 (via one or more API calls, for example) for displaying on a web page or GUI, a graphical display and/or text that is directed at obtaining from the user, information pertaining to the shared ride request. The user may enter into the GUI, information such as, for example, an origination address, a destination address, a date of travel, a desired time for originating the travel, a number of co-passengers desired, and/or one or more preferred characteristics of the co-passengers.

The user device transmits the information to the cloud computer 125 (for example, the smartphone 106 transmits a cellular signal to the cloud computer 125 via the wireless communication link 107) in a manner similar to that described above with reference to block 210.

At block 245, the cloud computer 125 receives the cellular signal from the user device and retrieves the digital data contained in the cellular signal in a manner similar to that described above with reference to block 215 and block 220.

At block 250, the cloud computer 125 may respond to the shared ride request initiated by the first user (at block 240) by accessing the data store and executing a search procedure to identify one or more other users who may be suitable for a shared ride with the first user. The search procedure can be based on at least some of the information provided by the first user (at block 240) such as, for example, an origination address, a destination address, a date of travel, a desired time for originating the travel, a number of co-passengers desired, and/or one or more preferred characteristics of the co-passengers.

The search procedure carried out automatically by the cloud computer 125 (with no human intervention) can involve operations such as matching and/or comparing information provided by the first user with user data of one or more other users that is stored in the data store.

The user data of the other users can include an online profile of each user, shared ride history of each user, and future shared rids of each user, and shared ride requests originated by one or more users.

In an example implementation, the search procedure may be executed by the cloud computer 125 based on machine learning software and/or artificial intelligence. The machine learning software and/or artificial intelligence may include one or more software modules that are configured to learn from the shared ride history of one or more users stored in the data store and to use the learning to match, for example, a shared ride request of one of the other users to the shared ride request originated by the first user (at block 240).

In an example scenario, the cloud computer 125 may, for example, execute a machine learning software module and/or an artificial intelligence software module that evaluates user data contained in the data store to learn personal preferences of one or more users. The results of the learning may, for example, enable the cloud computer 125 to disregard a first type of co-passenger, a first type of vehicle, and/or a first time of travel when executing the search procedure. Furthermore, the cloud computer 125 may, for example, and based on learning from the shared ride history of the first user and one or more other users, select a second type of co-passenger, a second type of vehicle, and/or a second time of travel when executing the search procedure.

The cloud computer 125 may also use other types of information to perform the search procedure. For example, the cloud computer 125 may identify a match based on user data of a second user that may include, for example, details of a desired shared ride by the second user. Some example details of the desired shared ride can include an origination location, a destination, a date of travel, and/or a time of travel desired by the second user. The destination may be entered in various forms such as, for example, by name (for example, an airport, a concert venue, a sports arena, etc.) or by address.

In an example operation, the search procedure is carried out by the cloud computer 125 searching the data store based on information provided by the first user (an origination address, a destination address, a date of travel, a desired time for originating the travel, etc.) and criteria provided by the first user (a number of co-passengers desired, and/or one or more preferred characteristics of the co-passengers). Thus, for example, the cloud computer 125 may identify, based on searching the data store, a shared ride request by a second user whose origination address and/or destination address is located within a first threshold distance of the origination address and/or destination address of the first user. As another example, the cloud computer 125 may identify, based on searching the data store in view of a preference indicated by the first user to share a ride with two co-passengers, a shared ride request by a third user whose origination address and/or destination address is located within a second threshold distance of the origination address and/or destination address of the first user. The first threshold distance and/or the second threshold distance may be automatically selected by the cloud computer based on various factors such as, for example, a travel route of the first user and an amount of time or an amount of deviation from the travel route that is acceptable to the first user. Such factors may be based, for example, of an evaluation by the cloud computer 125 of a shared ride history of the first user, a shared ride history of the second user, and/or a shared ride history of the third user. In an example embodiment, the evaluation may be based on a machine learning procedure executed by the cloud computer upon the user data of the first user, the user data of the second user, and the user data of the third user.

At block 255, the cloud computer 125 may execute a verification procedure upon one or more users who may be identified via the search procedure described above (such as, for example, the second user identified by a search procedure). In another embodiment, the cloud computer 125 may execute a verification procedure upon all users of the transport arrangement system such as, for example, before performing the action indicated at block 230.

The verification procedure not only provides privacy to the second user with respect to some details associated with the second user, but also provides security to the first user. Providing privacy to the second user can include, for example, hiding a residential address, a phone number, email address, family details, etc. of the second user, from the first user. Providing this security feature in accordance with the disclosure is in contrast to a traditional approach where a phone number or email address is used for enabling interaction between the first user and the second user. Any details pertaining to the second user that is provided to the first user (and/or vice-versa) is first verified, scrutinized, and filtered, by the cloud computer 125, thereby providing privacy as well as security to both users. Thus, in accordance with the disclosure, a curated version of details associated with any one user of the transport arrangement system is exposed to any other user of the transport arrangement system. In an example implementation, a curated version of details can include information that may be deemed generic by the cloud computer 125, such as, for example, information pertaining to a school or a church that is attended by the first user and the second user, a company that employs both the first user and the second user, and/or a neighborhood in which both the first user and the second user reside. In an example scenario, the curated version may be generated by the cloud computer 125 based on evaluating information such as, for example, personal identification (driving license, passport, etc.), occupational information (company, employer, etc.), social media presence (Facebook®, Twitter®, etc.), criminal history, and enrollment in various institutions (school, college, church, fraternity, club, etc.). The information that is evaluated by the cloud computer 125 may either be provided by each user during enrollment (prior to action indicated at block 230) or may be available via public records. Information available through public records may be accessed by the cloud computer 125 via interaction with other computers such as, for example, a computer of a driver's licensing issuing authority, a computer in a government agency, a computer in a police department, a computer in a prison system, etc.

After completion of the verification procedure, at block 260, the cloud computer 125 may provide to the first user, the curated data and/or travel data of the one or more users identified at block 250. This operation may be carried out by the cloud computer 125 transmitting information via a signal to the user device (a cellular signal to the smartphone 106, in this example). The signal can contain digital data pertaining to an output of the search procedure provided by the software application of the cloud computer 125 in response to the search request signal received from the user device at block 240. In one case, the output of the search procedure can include details associated with one or more proposed shared rides sought by one or more other users and curated details pertaining to the one or more other users.

The user device can receive the signal transmitted by the cloud computer 125 and retrieve the output of the search procedure from the signal in the manner described above with respect to block 220. The software application in the user device can display the output of the search procedure in the form of search results displayed on the GUI of the user device. In an example scenario, the search results may be displayed in the form of one or more travel routes of one or more other users overlaid upon a map. The overlaying of the travel route upon the map may be performed by the software in the user device or may be provided in the form of digital data in the signal received from the cloud computer 125. When performed by software in the user device, the map may be obtained from any of various sources such as, for example, from the cloud computer 125 or from a navigation system provided in the user device.

At block 265, a determination may be made to find out if the first user is interested in any of the items in the search result.

If the first user does not find the search results suitable, other actions such as, for example, initiation of a shared ride request (at block 240) may be made at a later time such as, for example, on a later day when more users may have provided additional user data or new user data to the data store (a new shared-ride request, for example).

If the first user finds the search results suitable, the first user provides a positive indication to the cloud computer 125 by use of the GUI on the user device. The user device may convey the positive indication to the cloud computer 125 (in the manner described above).

At block 280, the software application in the cloud computer 125 establishes a communication channel between the first device and a second device of another user to enable a generation, via the transport arrangement system as an intermediary to the first device and the second device, of shared ride data. The shared ride data may be generated by the cloud computer 125 on the basis of information provided by the first user device (based on input from the first user via the GUI on the first user device) and/or information provided by the second user device (based on input from the second user via the GUI on the second user device). In an example implementation, the shared ride data includes details of a shared ride to be undertaken by the first user and the second user. The cloud computer 125 thus allows interaction between two or more users (in this case, the first user and the second user) of the transport arrangement system. The two or more users can thus gain knowledge about each other prior to travel and can discuss details and preferences about a shared ride that may be carried out by the two or more users.

At block 275, a determination may be made whether an agreement has been reached between two or more users with respect to a shared ride such as, for example between the first user and the second user. If an agreement is not reached, such as, for example, if the first user finds the interaction unsatisfactory or unsuitable, other actions such as, for example, breaking off communications with the other users and/or initiation of a shared ride request (at block 240) may be made at a later time such as, for example, on a later day when more users may have provided additional user data or new user data to the data store (a new shared-ride request, for example).

If the first user finds the interaction satisfactory, the first user who originated the shared ride search may provide an indication via the GUI on the user device whether one or more of the shared rides sought by one or more other users and proposed by the cloud computer 125 is acceptable to the first user. The user device conveys the information to the cloud computer 125.

At block 280, the cloud computer 125 arranges for deployment of one or more resources to complete the shared ride. In an example scenario, deploying the one or more resources includes the cloud computer 125 automatically communicating with the external server computer 145 to make arrangements associated with a rental vehicle. The cloud computer 125 may communicate details of the deployment of the resource, which in this example, pertains to arrangements associated with the rental vehicle, to the user device of the first user and a user device of the second user, who can then proceed with completing the shared ride in the rental vehicle. In another example scenario, at block 270, the first user and the second user may discuss via the cloud computer 125 which acts as an intermediary between the first user device and the second user device, the use of a private vehicle (a personal vehicle of one of the first user or the second user, for example) for completing the shared ride.

At block 285, the cloud computer 125 may execute a coordination procedure for ensuring that the shared ride is carried out satisfactorily. The coordination procedure can include, for example, one or more operations carried out by the cloud computer 125 with respect to one or more users who are involved in the shared ride described above with reference to block 280. Example operations can include verifying the number of users undertaking the shared ride, a type of vehicle used for the shared ride (a personal vehicle, a ride share vehicle, a taxi, a limousine etc.), a travel status of each user (approved, canceled, pending, etc.), allowing time adjustments (pick up time, drop-off time, etc.), allowing location adjustments (pick up spot, drop-off spot, etc.), and feedback (a satisfaction survey, for example).

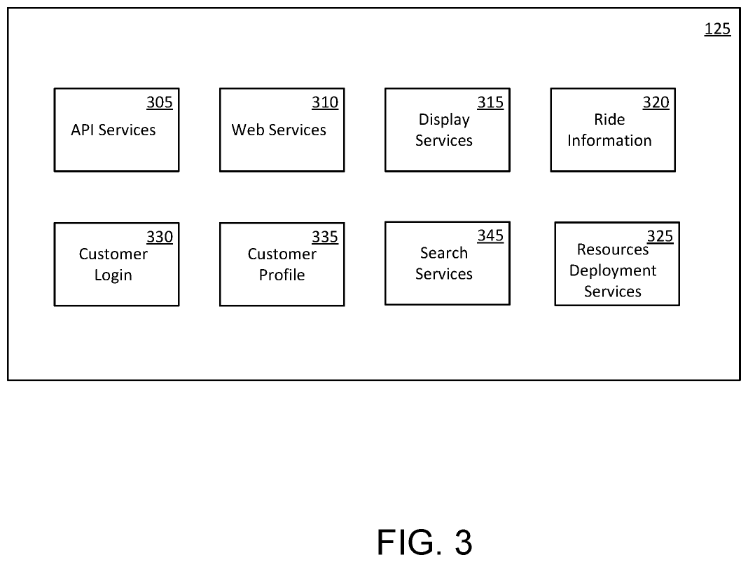

FIG. 3 illustrates some example functional blocks that can be performed by, or provided by, a computer that is configured to allow two or more people to make an arrangement to share a ride in a vehicle in accordance with the disclosure. The computer in this example illustration is the cloud computer 125.

The example functional blocks include API services 305, web services 310, display services 315, ride information 320, resources deployment services 325, customer login 330, customer profile 335, and search services 345. The functions indicated by the various functional blocks can be implemented in the form of computer-executable instructions that can be executed by a processor such as, for example, a processor of the cloud computer 125.

API services 305 enables a software application in the cloud computer 125 to communicate with a software application provided in a user device. In this case, the API services can cater to multiple user devices.

Web services 310 enable the cloud computer 125 to access various data sources and to display on the various user devices web content such as, for example, a map and a travel route.

Display services 315 enable the cloud computer 125 to display various content upon various user devices such as, for example, a query directed at a user of a device.

Ride information 320 generally pertains to information obtained by and/or generated by the cloud computer 125 with respect to shared rides.

Resources deployment services 325 generally pertains to services offered by the cloud computer 125 to various users such as, for example, reservations for a rental vehicle.

Customer login 330 and customer profile 335 generally pertain to information about various users that may be used for various purposes such as, for security and for payment towards renal fees and other costs associated with shared rides.

Search services 345 generally pertains to operations performed by the cloud computer 125 to identify one or more users whose user data matches a shared ride request of a user.

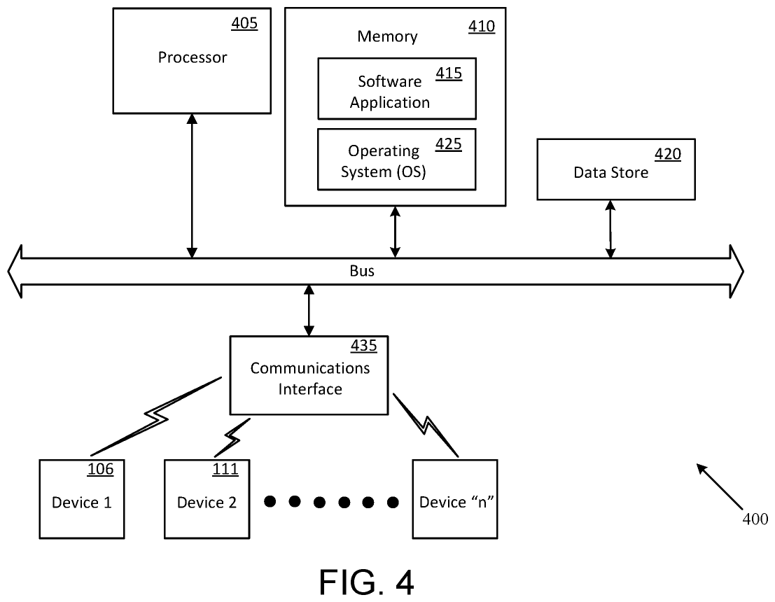

FIG. 4 shows some example components that can be included in a computer 400 that is configured to allow two or more people to make an arrangement to share a ride in a vehicle in accordance with the disclosure. The computer 400 can be the cloud computer 125 or any other computer that provides services to various users of a transport arrangement system in accordance with the disclosure.

The computer 400 may implement, execute, or perform, one or more aspects of the methods and techniques described herein. The computer 400 includes a communications interface 435, a processor 405, memory 410, a data store 420, and a communications interface 435. Although shown as a distinct unit, one or more of the components of the computer 400 may be integrated into respective distinct physical units. For example, the processor 405 may be integrated in a first physical unit and the communications interface 435 may be integrated in a second physical unit.

In some implementations, the computer 400 is a stationary device, such as, for example, a personal computer (PC), a server, a workstation, a minicomputer, or a mainframe computer. In some implementations, the computer 400 can be a mobile device, such as, for example, a mobile telephone, a personal digital assistant (PDA), a laptop, or a tablet computer.

The communications interface 435 communicates, such as transmits, receives, or exchanges, data via one or more wired, or wireless, electronic communication mediums, such as a radio frequency (RF) communication medium, an ultraviolet (UV) communication medium, a visible light communication medium, a fiber optic communication medium, a wireline communication medium, or a combination thereof. For example, the communications interface 435 may include, or may be, a transceiver. Although not shown separately in FIG. 4, the communications interface 435 may include, or may be operatively coupled with, an antenna for wireless electronic communication. Although not shown separately in FIG. 4, the communications interface 435 may include, or may be operatively coupled with, a wired electronic communication port, such as an Ethernet port, a serial port, or another wired port, that may interface with, or may be operatively coupled to, a wired electronic communication medium. In some implementations, the communications interface 435 may be or may include a network interface card (NIC) or unit, a universal serial bus (USB), a Small Computer System Interface (SCSI), a Peripheral Component Interconnect (PCI), a near field communication (NFC) device, card, chip, or circuit, or another component for electronic data communication between the computer 400, or one or more of the components thereof, and one or more external electronic or computing devices. Although shown as one unit in FIG. 4, the communications interface 435 may include multiple physical components, such as a wired data interface and a wireless data interface.

For example, the computer 400 may electronically communicate, such as transmit, receive, or exchange computer accessible data, with one or more other devices (such as, for example “n” user devices n≥1) via one or more wired or wireless communication links, or connections, such as via a network, using the communications interface 435, which may include using one or more electronic communication protocols, which may be network protocols, such as Ethernet, Transmission Control Protocol/Internet Protocol (TCP/ IP), user datagram protocol (UDP), power line communication (PLC), infrared, ultra violet (UV), visible light, fiber optic, wire line, general packet radio service (GPRS), Global System for Mobile communications (GSM), code-division multiple access (CDMA), Long-Term Evolution (LTE), Universal Mobile Telecommunications System (UMTS), Institute of Electrical and Electronics Engineers (IEEE) standardized protocols, or other suitable protocols.

The processor 405 is a device, a combination of devices, or a system of connected devices, capable of manipulating or processing an electronic, computer accessible, signal, or other data, such as an optical processor, a quantum processor, a molecular processor, or a combination thereof.

In some implementations, the processor 405 is implemented as a central processing unit (CPU), such as a microprocessor. In some implementations, the processor 405 is implemented as one or more special purpose processors, one or more graphics processing units, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, firmware, one or more state machines, or a combination thereof.

The processor 405 includes one or more processing units. A processing unit may include one or more processing cores. The computer 400 may include multiple physical or virtual processing units (collectively, the processor 405), which may be interconnected, such as via wired, or hardwired, connections, via wireless connections, or via a combination of wired and wireless connections. In some implementations, the processor 405 is implemented in a distributed configuration including multiple physical devices or units that may be coupled directly or across a network. The processor 405 includes internal memory (not expressly shown), such as a cache, a buffer, a register, or a combination thereof, for internal storage of data, such as operative data, instructions, or both. For example, the processor 405 may read data from the memory 410 into the internal memory (not shown) for processing.

The memory 410 is a non-transitory computer-usable or computer-readable medium, implemented as a tangible device or component of a device. The memory 410 contains, stores, communicates, transports, or a combination thereof, data, such as operative data, instructions, or both. For example, the memory 410 stores an operating system (OS) 425 of the computer 400, or a portion thereof. The memory 410 contains, stores, communicates, transports, or a combination thereof, data, such as operative data, instructions, or both associated with implementing, or performing, the methods and techniques, or portions or aspects thereof, described herein. For example, the non-transitory computer-usable or computer-readable medium may be implemented as a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or another type of non-transitory media suitable for storing electronic data, or a combination thereof. The memory 410 may include non-volatile memory, such as a disk drive, or another form of non-volatile memory capable of persistent electronic data storage, such as in the absence of an active power supply. The memory 410 may include, or may be implemented as, one or more physical or logical units.

The memory 410 stores executable instructions or data, such as application data, an operating system, or a combination thereof, for access, such as read access, write access, or both, by the other components of the computer 400, such as by the processor 405. The executable instructions may be organized as program modules or algorithms, functional programs, codes, code segments, or combinations thereof to perform one or more aspects, features, or elements of the methods and techniques described herein. The application data may include, for example, user files, database catalogs, configuration information, or a combination thereof. The operating system may be, for example, a desktop or laptop operating system; an operating system for a mobile device, such as a smartphone or tablet device; or an operating system for a large device, such as a mainframe computer. For example, the memory 410 may be implemented as, or may include, one or more dynamic random-access memory (DRAM) modules, such as a Double Data Rate Synchronous Dynamic Random-Access Memory module, Phase-Change Memory (PCM), flash memory, or a solid-state drive.

In the illustrated example, the memory 410 includes a software application 415 and the OS 425. The software application 415 can be executed by the processor 405 for performing various actions in accordance with the disclosure, such as, for example, some of the actions described above with respect to the method 200 (FIG. 2) and the functions shown in FIG. 3. The data store 420 can be configured to store various types of data that may be accessed by the processor 405 for performing various actions in accordance with the disclosure. Some examples of data that can be stored in the data store 420 are described above with reference to FIG. 3.

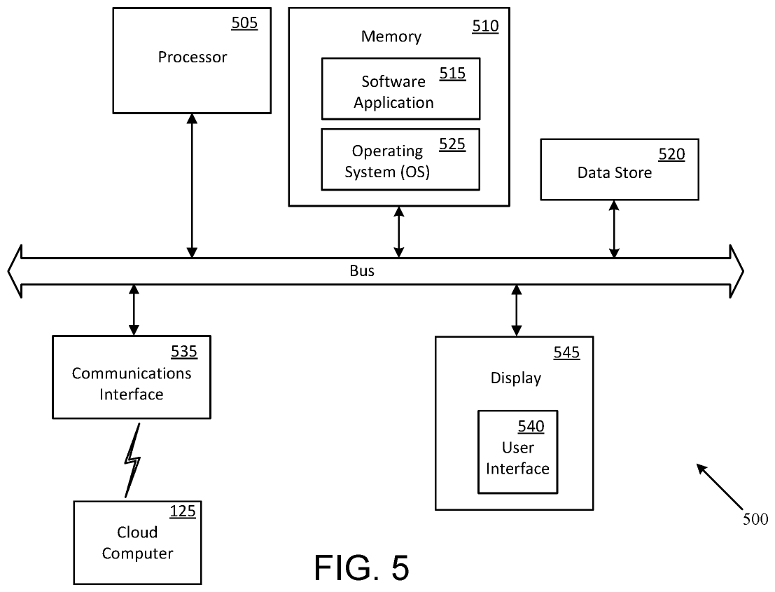

FIG. 5 shows some example components that can be included in a device 500 that may be used by a user of the transportation arrangement system to make an arrangement to share a ride in a vehicle in accordance with the disclosure. The device 500 can be any device such as, for example, the smartphone 106, the laptop computer 111 of the user 110 and the desktop computer 121 of the user 120, that may be used to utilize a transport arrangement system in accordance with the disclosure.

Various portions of the description provided above with respect to the processor 405 is equally applicable to the processor 505 and will not be repeated here. Various portions of the description provided above with respect to the memory 410 is equally applicable to the memory 510 and will not be repeated here.

In the illustrated example, the memory 510 includes a software application 515 and an OS 525. The software application 515 can be executed by the processor 505 for performing various actions in accordance with the disclosure, such as, for example, some of the actions described above with respect to the method 200. A data store 520 can be configured to store various types of data that may be accessed by the processor 505 for performing various actions in accordance with the disclosure.

Some other example components that can be included in a device 500 are a communications interface 535, a user interface 540, and a display 545. Various portions of the description provided above with respect to the communications interface 435 is equally applicable to the communications interface 535 and will not be repeated here. However, with respect to the device 500, the communications interface 535 is configured to allow the device 500 to communicate with devices such as, for example, the cloud computer 125 for performing various actions in accordance with the disclosure.

The display 545, which can include a user interface 540, is configured to display various types of visual content to a user of the device 500 such as, for example, a GUI, a map, a travel route, etc.

The implementations of this disclosure can correspond to methods, systems, non-transitory computer readable media, devices, and the like for facilitating a shared ride. In some implementations, a method may include accessing, in response to a shared ride request obtained from a first device associated with one user of a transport arrangement system, a data store of the transport arrangement system to identify user data associated with one or more users of the transport arrangement system; executing, by one or more processors of the transport arrangement system, instructions stored within a memory of the transport arrangement system and associated with search software of the transport arrangement system to identify at least one other user of the transport arrangement system; establishing, based on an output of the search software, a communication channel between the first device and a second device of the at least one other user to enable a generation, via the transport arrangement system as an intermediary to the first device and the second device, of shared ride data; and causing a deployment of one or more resources to facilitate a shared ride between the one user and the at least one other user according to the shared ride data.

In some implementations of the method can further involve the one or more processors of the transport arrangement system executing instructions stored within the memory of the transport arrangement system and associated with display software of the transport arrangement system to cause a display, on a display screen of the first device, of a map that includes a travel route of the at least one other user of the transport arrangement system, wherein the deployment of the one or more resources is based at least in part on the travel route.

In some implementations of the method, causing the deployment of the one or more resources to facilitate the shared ride may include arranging a vehicle for the shared ride between the one user and the at least one other user.

In some implementations of the method, arranging the vehicle for the shared ride may include the one or more processors of the transport arrangement system executing instructions stored within the memory of the transport arrangement system to arrange for a vehicle to complete the shared ride.

In some implementations of the method, the vehicle can be one of a private vehicle or a rental vehicle

In some implementations of the method, the search software of the transport arrangement system includes machine learning software configured to learn a personal preference of the one user of the transport arrangement system based on a travel history of at least the one user.

In some implementations of the method, the shared ride data generated via the transport arrangement system may include a first destination of the one user of the transport arrangement system and a second destination of the one other user of the transport arrangement system.

In some implementations, a method may include transmitting, by a first device associated with a first user of a transportation arrangement system, based on executing instructions stored within a memory of the first device, to the transportation arrangement system, a first request to obtain from the transportation arrangement system, one or more proposed shared rides sought by one or more other users of the transport arrangement system; receiving, by the first device, from the transportation arrangement system, information about at least a first proposed shared ride sought by a second user of a second device; establishing, by the first device with the second device, via the transport arrangement system operating as an intermediary to the first device and the second device, a communication to discuss a shared ride; transmitting, by the first device to the transportation arrangement system, based on executing instructions stored within the memory of the first device, a second request to arrange for deployment of a resource to facilitate the shared ride of the first user and the second user; and receiving, by the first device from the transportation arrangement system, information about the deployment of the resource.

In some implementations of the method, the communication to discuss establishing the shared ride may involve receiving, by the first device, from the transportation arrangement system, a map that includes a travel route of the at least one other user of the transport arrangement system; and displaying, by the first device, the map, on a display screen of the first device.

In some implementations of the method, deployment of the resource may include deploying of one of a private vehicle or a rental vehicle.

In some implementations of the method, deployment of the resource may include deploying of a rental vehicle.

In some implementations of the method, the at least one other user is selected by the transport arrangement system based on machine learning software.

In some implementations of the method, the machine learning software may be configured to learn from a travel history of at least one of the one user or the at least one other user of the transportation arrangement system.

In some implementations, a transportation arrangement system includes a data store, a memory, and a processor. The data store contains user data associated with one or more users of the transport arrangement system. The memory stores computer-executable instructions. The processor is configured to access the memory and execute the computer-executable instructions to perform operations that may include performing, in response to a shared ride request obtained from a first device associated with one user of the transport arrangement system, a search of the data store to identify at least one other user of the transport arrangement system; establishing, based on the search, a communication channel between the first device and a second device of the at least one other user of the transport arrangement system to enable a generation of shared ride data; and causing a deployment of one or more resources to facilitate a shared ride between the one user and the at least one other user according to the shared ride data.

In some implementations of the transportation arrangement system, the processor is further configured to access the memory and execute the computer-executable instructions to perform operations that may include displaying, on a display screen of the first device, a map comprising a travel route of the at least one other user of the transport arrangement system.

In some implementations of the transportation arrangement system, causing the deployment of the one or more resources to facilitate the shared ride involves arranging a vehicle for the shared ride between the one user and the at least one other user.

In some implementations of the transportation arrangement system, the processor is further configured to access the memory and execute the computer-executable instructions to perform operations comprising arranging for a rental vehicle.

In some implementations of the transportation arrangement system, the vehicle is one of a private vehicle or a rental vehicle.

In some implementations of the transportation arrangement system, the computer-executable instructions stored in the memory comprises machine learning software that is configured to learn a personal preference of at least the one user of the transport arrangement system based on a travel history of the one user.

In some implementations of the transportation arrangement system, the shared ride data includes a first destination of the one user of the transport arrangement system and a second destination of the one other user of the transport arrangement system.

To the extent that the respective aspects, features, or elements of the devices, apparatus, methods, and techniques described or shown herein, are shown or described as a respective sequence, order, configuration, or orientation, thereof, such sequence, order, configuration, or orientation is explanatory and other sequences, orders, configurations, or orientations may be used, which may be include concurrent or parallel performance or execution of one or more aspects or elements thereof, and which may include devices, methods, and techniques, or aspects, elements, or components, thereof, that are not expressly described herein, except as is expressly described herein or as is otherwise clear from context. One or more of the devices, methods, and techniques, or aspects, elements, or components, thereof, described or shown herein may be omitted, or absent, from respective embodiments.

The figures, drawings, diagrams, illustrations, and charts, shown and described herein express or represent the devices, methods, and techniques, or aspects, elements, or components, thereof, as disclosed herein. The elements, such as blocks and connecting lines, of the figures, drawings, diagrams, illustrations, and charts, shown and described herein, or combinations thereof, may be implemented or realized as respective units, or combinations of units, of hardware, software, or both.

Unless expressly stated, or otherwise clear from context, the terminology “determine,” “identify,” and “obtain,” and variations or wordforms thereof, indicates selecting, ascertaining, computing, looking up, receiving, determining, establishing, obtaining, or otherwise identifying or determining using one or more of the devices and methods shown and described herein. Unless expressly stated, or otherwise clear from context, the terminology “example,” and variations or wordforms thereof, such as “embodiment” and “implementation,” indicates a distinct, tangible, physical realization of one or more aspects, features, or elements of the devices, methods, and techniques described herein. Unless expressly stated, or otherwise clear from context, the examples described herein may be independent or may be combined.

Unless expressly stated, or otherwise clear from context, the terminology “or” is used herein inclusively (inclusive disjunction), rather than exclusively (exclusive disjunction). For example, unless expressly stated, or otherwise clear from context, the phrase “includes A or B” indicates the inclusion of “A,” the inclusion of “B,” or the inclusion of “A and B.” Unless expressly stated, or otherwise clear from context, the terminology “a,” or “an,” is used herein to express singular or plural form. For example, the phrase “an apparatus” may indicate one apparatus or may indicate multiple apparatuses. Unless expressly stated, or otherwise clear from context, the terminology “including,” “comprising,” “containing,” or “characterized by,” is inclusive or open-ended such that some implementations or embodiments may be limited to the expressly recited or described aspects or elements, and some implementations or embodiments may include elements or aspects that are not expressly recited or described.

As used herein, numeric terminology that expresses quantity (or cardinality), magnitude, position, or order, such as numbers, such as 1 or 20.7, numerals, such as “one” or “one hundred,” ordinals, such as “first” or “fourth,” multiplicative numbers, such as “once” or “twice,” multipliers, such as “double” or “triple,” or distributive numbers, such as “singly,” used descriptively herein are explanatory and non-limiting, except as is described herein or as is otherwise clear from context. For example, a “second” element may be performed prior to a “first” element, unless expressly stated, or otherwise clear from context.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

That which is claimed is:

1. A method, comprising:
accessing, in response to a shared ride request obtained from a first device associated with one user of a transport arrangement system, a data store of the transport arrangement system to identify user data associated with one or more users of the transport arrangement system;
executing, by one or more processors of the transport arrangement system, instructions stored within a memory of the transport arrangement system and associated with search software of the transport arrangement system to identify at least one other user of the transport arrangement system;
establishing, based on an output of the search software, a communication channel between the first device and a second device of the at least one other user to enable a generation, via the transport arrangement system as an intermediary to the first device and the second device, of shared ride data; and
causing a deployment of one or more resources to facilitate a shared ride between the one user and the at least one other user according to the shared ride data.

2. The method of claim 1, further comprising:
executing, by the one or more processors of the transport arrangement system, instructions stored within the memory of the transport arrangement system and associated with display software of the transport arrangement system to cause a display, on a display screen of the first device, of a map comprising a travel route of the at least one other user of the transport arrangement system, wherein the deployment of the one or more resources is based at least in part on the travel route.

3. The method of claim 1, wherein causing the deployment of the one or more resources to facilitate the shared ride comprises arranging a vehicle for the shared ride between the one user and the at least one other user.

4. The method of claim 3, wherein arranging the vehicle for the shared ride comprises the one or more processors of the transport arrangement system executing instructions stored within the memory of the transport arrangement system to arrange for a vehicle to complete the shared ride.

5. The method of claim 3, wherein the vehicle is one of a private vehicle or a rental vehicle.

6. The method of claim 1, wherein the search software of the transport arrangement system comprises machine learning software configured to learn a personal preference of the one user of the transport arrangement system based on a travel history of at least the one user.

7. The method of claim 1, wherein the shared ride data generated via the transport arrangement system comprises a first destination of the one user of the transport arrangement system and a second destination of the one other user of the transport arrangement system.

8. A method comprising:
transmitting, by a first device associated with a first user of a transportation arrangement system, based on executing instructions stored within a memory of the first device, to the transportation arrangement system, a first request to obtain from the transportation arrangement system, one or more proposed shared rides sought by one or more other users of the transport arrangement system;
receiving, by the first device, from the transportation arrangement system, information about at least a first proposed shared ride sought by a second user of a second device;
establishing, by the first device with the second device, via the transport arrangement system operating as an intermediary to the first device and the second device, a communication to discuss establishing a shared ride;
transmitting, by the first device to the transportation arrangement system, based on executing instructions stored within the memory of the first device, a second request to arrange for deployment of a resource to facilitate the shared ride of the first user and the second user; and
receiving, by the first device from the transportation arrangement system, information about the deployment of the resource.

9. The method of claim 8, wherein the communication to discuss establishing the shared ride comprises:
receiving, by the first device, from the transportation arrangement system, a map comprising a travel route of the second user of the transport arrangement system; and
displaying, by the first device, the map, on a display screen of the first device.

10. The method of claim 8, wherein deployment of the resource comprises deploying of one of a private vehicle or a rental vehicle.

11. The method of claim 8, wherein deployment of the resource comprises deploying of a rental vehicle, and wherein receiving, from the transportation arrangement system, information about the rental vehicle comprises receiving a first amount to be paid by the one user to a vehicle rental agency and a second payment amount to be paid by the second user to the vehicle rental agency.

12. The method of claim 8, wherein the second user is selected by the transport arrangement system based on machine learning software.

13. The method of claim 12, wherein the machine learning software is configured to learn from a travel history of the first user or the second user of the transportation arrangement system.

14. A transportation arrangement system comprising:
a data store containing user data associated with one or more users of the transport arrangement system;
a memory that stores computer-executable instructions; and
a processor configured to access the memory and execute the computer-executable instructions to perform operations comprising:
performing, in response to a shared ride request obtained from a first device associated with one user of the transport arrangement system, a search of the data store to identify at least one other user of the transport arrangement system;
establishing, based on the search, a communication channel between the first device and a second device of the at least one other user of the transport arrangement system to enable a generation of shared ride data; and
causing a deployment of one or more resources to facilitate a shared ride between the one user and the at least one other user according to the shared ride data.

15. The transportation arrangement system of claim 14, wherein the processor is further configured to access the memory and execute the computer-executable instructions to perform operations comprising:
displaying, on a display screen of the first device, a map comprising a travel route of the at least one other user of the transport arrangement system.

16. The transportation arrangement system of claim 14, wherein causing the deployment of the one or more resources to facilitate the shared ride comprises arranging a vehicle for the shared ride between the one user and the at least one other user.

17. The transportation arrangement system of claim 16, wherein the processor is further configured to access the memory and execute the computer-executable instructions to perform operations comprising:
arranging for a first payment to a vehicle rental agency by the one user and a second payment to the vehicle rental agency by the at least one other user.

18. The transportation arrangement system of claim 17, wherein the vehicle is one of a private vehicle or a rental vehicle.

19. The transportation arrangement system of claim 17, wherein the computer-executable instructions stored in the memory comprises machine learning software that is configured to learn a personal preference of at least the one user of the transport arrangement system based on a travel history of the one user.

20. The transportation arrangement system of claim 15, wherein the shared ride data comprises a first destination of the one user of the transport arrangement system and a second destination of the one other user of the transport arrangement system.
